(19) United States
(12) Patent Application Publication
(10) Pub. No.: US 2009/0183299 A1
(43) Pub. Date: Jul. 23, 2009

(54) BAND

(76) Inventor: Daniel Peter Conway, Victoria (AU)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 12/306,869

(22) PCT Filed: Jul. 12, 2007
(86) PCT No.: PCT/AU2007/000946

§ 371 Date: Dec. 29, 2008

(30) Foreign Application Priority Data
Jul. 21, 2006 (AU) 2006903933

(51) Int. Cl. A41D 20/00; B65D 25/00; B42D 15/00

(52) U.S. Cl. 2/170; 220/739; 283/56

(57) ABSTRACT

A neoprene band including a first strip member and a second strip member which underlies and attaches to the first strip member forming a pocket therebetween is provided. Fastening elements are present as a hook and loop fastener strip and an adhesive portion at opposed ends of the first strip member. The band has a first use mode in which it is adapted to be fitted on the limb of a user and a second use mode in which it is adapted to surround and insulate a vessel.

### FIELD OF THE INVENTION

The present invention relates to a band. In a particular aspect the invention relates to a band for a wrist, arm, or ankle which may be used to surround and insulate a vessel.

### BACKGROUND OF THE INVENTION

In the past bands for wrists or ankles have been broadly used for identifying a feature of or associated with a wearer, or for providing functional assistance to the wearer. More specifically, wrist bands have been used for: admission to concerts, drinking age verification at public bars, crowd control at festivals, patient identification in hospitals, indication of age or height at amusement parks with restricted rides, promotion of charitable campaigns, support or magnetic therapy of painful wrists, sweat absorption whilst playing sports, holding wrist watches, and styling outfits as fashion accessories.

It is recognised that there have been many and varied traditional uses for wrist bands. Given the fact that wrist bands are accepted by people for a large range of uses, any creative enhancement of their range of uses and/or their marketing impact would be very desirable in a range of situations. The present invention seeks to provide a creative enhancement of wrist, arm, or ankle bands and their usage.

### DISCLOSURE OF THE INVENTION

The invention provides a band of flexible insulating material having two use modes, the band being adapted to be fitted on the limb of a user in a first use mode and adapted to surround and insulate a vessel in a second use mode. In a particular form, the band is adapted to be fitted on the wrist, arm, or ankle of a user.

The band may comprise a first strip member having opposed ends. The first strip member may be elasticised, waterproof, or resistant to high pressures. The first strip member may be manufactured from neoprene, foam, plastic, woven material, or any combination of two or more of these. A type of neoprene used in the first strip member may be Solaflex. The first strip member may comprise an insulating and flexible foam blend.

The first strip member may comprise a skin. The skin may be flexible and printable. The skin may comprise a synthetic material such as nylon or a polyester blend.

Fastening elements may be cooperatively disposed proximate the opposed ends of the first strip member so that the opposed ends may be fastened together. One of the fastening elements may substantially cover an entire surface of the first strip member from end to end. The fastening elements may allow adjustable fastening so as to accommodate limbs and vessels of various shapes and sizes. The fastening elements may comprise stud, Velcro hook and loop, or Velcro hook and adhesive blend (e.g. polyester blend) material or buckle arrangements. Velcro adhesive fabric may substantially cover an entire surface of the first strip member so that a Velcro hook portion may be fastened to substantially any part of the Velcro adhesive covered surface thereby allowing for significant size adjustability of the band when being fitted on the user's limb or surrounding the vessel.

The band may comprise a second strip member. The second strip member may underlie and attach to the first strip member. The second strip member may be elasticised, waterproof, or resistant to high pressures. The second strip member may be manufactured from neoprene, foam, plastic, woven material, or any combination of two or more of these. A type of neoprene used in the second strip member may be Solaflex. The second strip member may comprise an insulating and flexible foam blend. The second strip member may not underlie the fastening elements disposed on the first strip member.

The second strip member may comprise a skin. The skin may be flexible and printable. The skin may comprise a synthetic material such as nylon or a polyester blend.

The band may be adapted to display advertising. The advertising may comprise a brand name or logo, a message, or user information. The advertising may be of the product around which the band is used. The advertising may be printed on, embroidered with, or attached to the band's inner or outer surface in use.

The band may comprise a pocket. The pocket may be defined by a region between the first and second strip members. The pocket may be adapted to hold the user's personal items. This pocket may also be adapted to display at least one of advertising and a size adjustable guide. The pocket may comprise closing means. The closing means may comprise a hook and loop fastener, zip, or stud. The band may comprise more than one pocket.

A curved resilient rod may be secured along opposed edges of the band so as to provide increased rigidity for the band and to give it a curved shape.

The invention also provides a method of marketing comprising using a band of flexible insulating material to display advertising, the band having two use modes whereby the band is adapted to be fitted on the wrist of a user in a first use mode and adapted to surround and insulate a vessel in a second use mode. The advertising may be displayed on at least one of an inner surface of the band and an outer surface of the band. In a particular form the advertising displayed on the band is of a product contained in the vessel.

### BRIEF DESCRIPTION OF THE DRAWINGS

By way of example only, embodiments of the invention are described more fully hereinafter with reference to the accompanying drawings, in which:—

FIG. 1 is a back isometric view of a band according to a preferred embodiment of the invention;

FIG. 2 is a front isometric view of the band of FIG. 1, showing the band fitted on the wrist of a user in a first use mode;

FIG. 3 is a front isometric view of the band of FIG. 1, showing the band surrounding and insulating a vessel in a second use mode;

FIG. 4 is a back plan view of a first alternative band according to a preferred embodiment of the invention;

FIG. 5 is a back plan view of a second alternative band, showing a size adjustment guide which may be displayed on the back or front surface of the band; and

FIG. 6 is a front plan view of the band of FIG. 5, showing a Velcro adhesive portion covering the entire front surface of the band.

### DETAILED DESCRIPTION OF THE DRAWINGS

The various elements identified by integers in the drawings are listed in the following integer list.

### INTEGER LIST

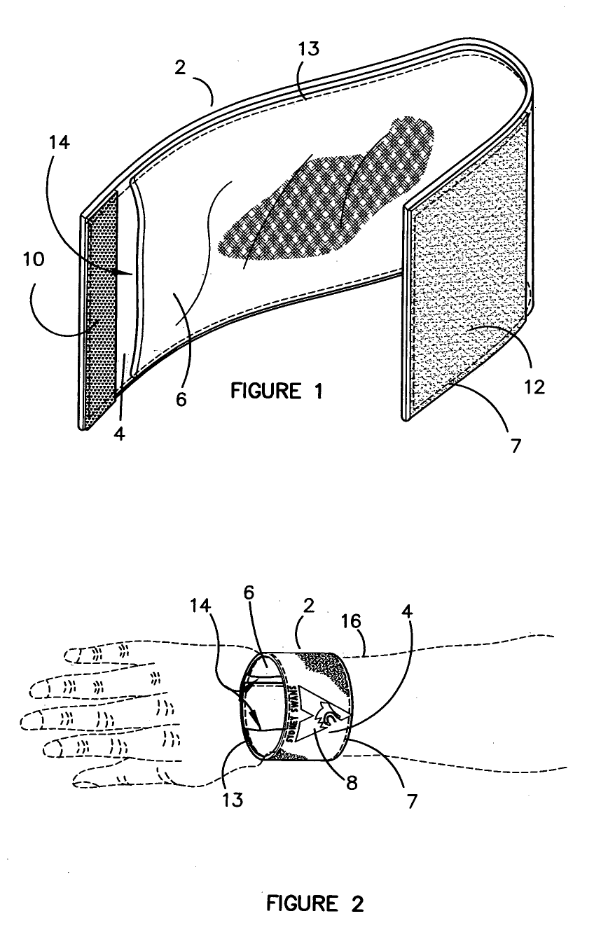

2 Band
4 First strip member
6 Second strip member
7 Location of stitching for first strip member
8 Location of advertising/printing on first strip member
10 Velcro hook strip
12 Velcro adhesive portion
13 Location of stitching for second strip member (and first strip member)
14 Pocket
16 Wrist
18 Bottle
20 Studs
22 Studs
24 Stud receiving members
26 Size adjustment guide
27 Large Pocket
28 Small Pocket
30 Location of advertising/printing on second strip member
32 Location of band branding
34 Location of stitching separating large and small pockets
   Referring to FIGS. 1 to 3, there is shown a band 2 comprising a first strip member 4 and a second strip member 6.

The first strip member 4 is an elongated rectangular strip being typically eighteen to thirty five centimetres in length, four to nine centimetres in width, and one to ten millimetres in thickness. Bands 2 designed to accommodate users with large arms or wrists, or large vessels such as soft drink cans, may have generally larger dimensions than bands designed to accommodate users with smaller arms or wrists, or smaller vessels such as bottled soft drinks or drinking glasses. Types of neoprene material, such as Solaflex, are suitable for use in the manufacture of the first strip member 4 because of their waterproof, elastic, soft, pressure resistant, and insulating properties. However it is envisaged that many other materials such as plastics, foam, rubber, and woven materials with similar or other properties may also be suitable for use in the manufacture of the first strip member 4.

A nylon skin may be glued to, and entirely coat, the front and back surfaces of the neoprene material. A continuous stitching such as an overlocking stitch, the position of which is indicated by broken line 7, provides a strong durable finish to the sides and edges of the first strip member 4.

Advertising 8 is printed on the nylon coat at the front surface of the first strip member 4. However it is envisaged that the advertising 8 may be displayed by some other means such as embroidery, or an attachment to the surface of the band 2. The advertisement in this instance is supporting the Sydney Swans football club and promoting a hypothetical Sydney Swans branded sports drink. There is an extremely wide range of products (e.g. clothes) having brand names (e.g. Billabong) which may benefit from advertising 8 on the first strip member 4. In particular, a manufacturer of a product contained in a vessel that can be surrounded by the band 2 (e.g. C.U.B. who produce Victoria Bitter beer in bottle, or The Coca Cola Company who produce Coca Cola in cans) may achieve a significant commercial advantage by advertising the brand of their product on the band 2. Stylish designs may also be displayed on the first strip member 4 to make the band 2 a more appealing fashion accessory.

Fastening elements are disposed at opposed ends of the first strip member 4 and allow the opposed ends to be fastened. The fastening elements include hook and loop fasteners in the form of a Velcro strip 10 on the back surface of the first strip member 4, and a Velcro adhesive portion 12 on the front surface of the first strip member 4. The Velcro strip 10 is rectangularly shaped, extending typically one to three centimetres along the length of the first strip member 4 and extending approximately from long side to long side along the width of the first strip member 4. The Velcro adhesive portion 12 is also rectangular in shape extending approximately from long side to long side along the width of the first strip member 4, and extending far enough along the length of the first strip member 4 (approximately 6.5 centimetres in this instance) to adequately allow for variability in the position of attachment of the Velcro strip 10 so that the band 2 may take on various shapes and sizes when the Velcro strip 10 is fastened to the Velcro adhesive portion. It is envisaged that the Velcro adhesive portion 12 may cover the entire front surface of the first strip member 4 thereby forming a fully size adjustable band which may be applied to vessels and limbs of various shapes and sizes. In this embodiment the Velcro adhesive portion is made of a polyester blend which is adapted to adhere to the Velcro hook strip 19, but it should be recognised that there are many other Velcro adherent materials which are also suitable.

The band may be formed with a pocket 14 by the addition of the second strip member 6. It may typically have the same thickness as the first strip member 4. Like the first strip member 4, the second strip member 6 is also rectangular in shape, being approximately one to five millimetres thick, and comprising a neoprene material coated with a thin nylon or polyester skin. The second strip member 6 underlies the first strip member 4, extending approximately from long side to long side along the width of the first strip member 4, and extending along the length of the first strip member 4 intermediate and proximate to the fastening elements. The long sides of the second strip member 6 are stitched with an overlocking stitch, as indicated by broken line 13 (which line is coterminus with the line indicating the position of overlooking stitch 7 of the first strip member 4), giving them a strong and durable finish along the edges. The long sides of the second strip member 6 are additionally stitched together along the long sides of the first strip member 4. This line of joining stitching is coterminus with the overlooking stitches 7 and 13 on the first and second strip member.

The second strip member 6 provides additional thickness to the band 2 so that when a user holds the vessel, transfer of heat from the user's hand into the vessel is limited. However, in order to maintain a reasonably consistent thickness throughout the band 2 in use, the second strip member 6 does not underlie the fastening elements. This arrangement allows for the additional thickness created in the band by portions of the first strip member 4 and fastening elements overlapping when the band 2 is fastened for use.

The pocket 14 is defined by a region between the back surface of the first strip member 4 and a front surface of the second strip member 6, the openings of the pocket 14 being located at opposed ends of the second strip member 6. The pocket 14 may be used to store and carry a user's personal items such as cash, cards or keys.

A pair of resilient rods such as moulded plastic rods (not shown) may extend proximate the long sides of the second strip member 6, being stitched in position between the first and second strip members 4, 6. The pair of rods may provide more rigidity to the band 2 and give it a resting curved shape.

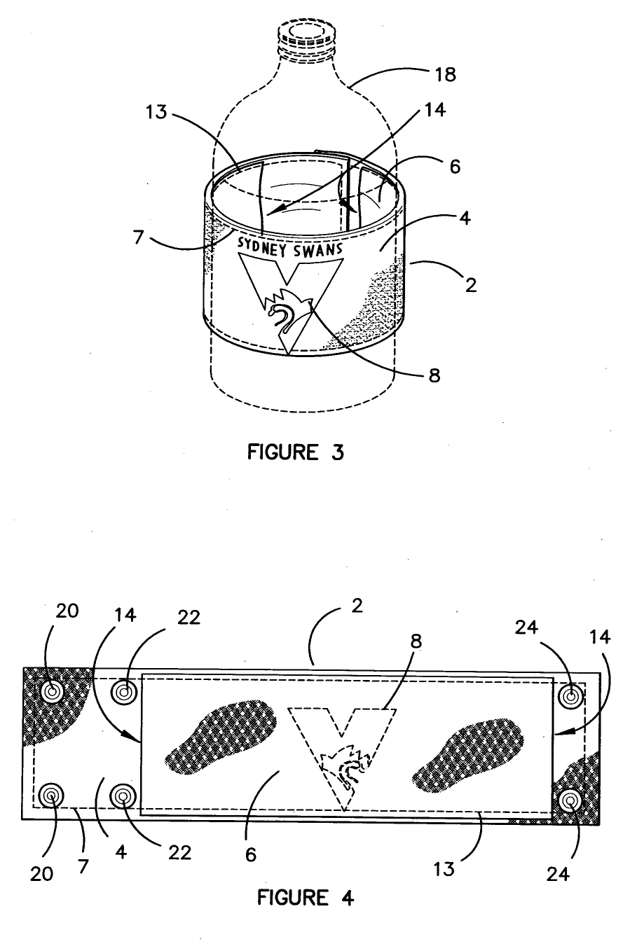

In a first use mode (FIG. 2), the band 2 is fitted on the wrist 16 of a user by fastening the Velcro hook strip 10 to the Velcro adhesive surface 12. When fitted to the user's wrist 16 the advertising 8 is displayed on the outer surface of the band 2. In this instance, the advertising 8 displayed is supporting the Sydney Swans football club and promoting a product (i.e. Sydney Swans sports drink) which may be surrounded by the band 2 in a second use mode (FIG. 3).

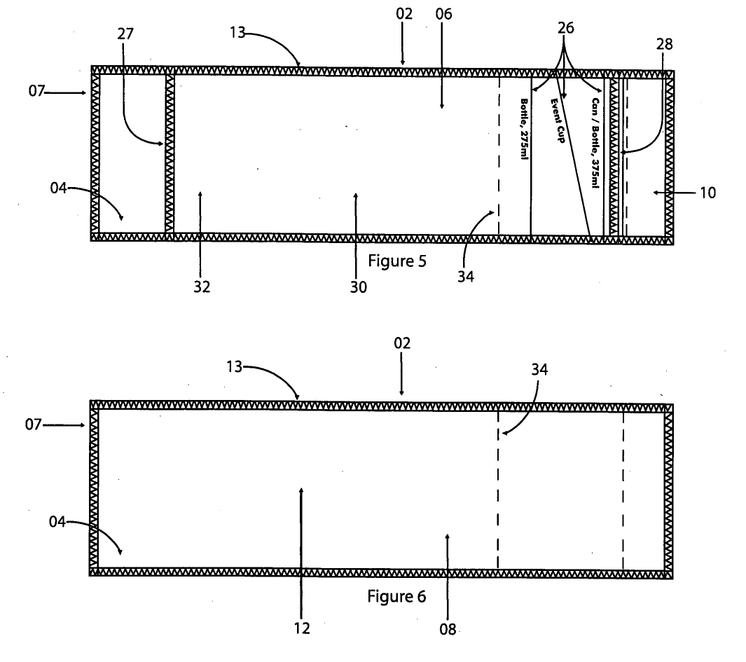

In the second use mode (FIG. 3) the band 2 is fastened to suit the shape of a bottle 18 containing Sydney Swans sports drink so that it surrounds and insulates the bottle 18. A size adjustment guide 26 (as hereinafter described with reference to FIG. 5) may assist the user in determining the position at which the Velcro strip 10 is fastened to the Velcro adhesive portion 12. Once surrounding the bottle 18, the band 2 insulates the bottle 18 so that when the user holds the bottle, transference of heat from the user's hand to the liquid inside the vessel is limited. The advertising 8 for the product in the bottle 18 (i.e. Sydney Swans branded sports drink) is displayed on the outer surface of the band 2.

Referring to FIG. 4, there is shown a back elevational view of a first alternative band 2 which is similar to the band 2 shown in FIGS. 1 to 3 but comprises different fastening elements. The fastening elements of the alternative band 2 include two pairs of studs 20, 22 (replacing the Velcro adhesive portion 12 of the band 2 shown in FIGS. 1 to 3) and a pair of stud receiving members 24 (replacing the Velcro strip 10 of the band 2 shown in FIGS. 1 to 3).

Each of the studs 20, 22 has a knob (not shown) projecting from the front surface of the first strip member 4. The knobs are adapted to articulate with the stud receiving members 24 on the back surface of the first strip member 4. In use, the band 2 is fitted on the wrist 16 of a user, or placed around a vessel, by fastening the pair of stud receiving members 24 to the knobs projecting from the pair of studs 20. For a tighter fit, the user may fasten the stud receiving members 24 to the knobs projecting from the pair of studs 22, instead of the pair of studs 20.

Referring to FIG. 5, a back plan view of a second alternative band illustrates a size adjustment guide 26 which may be printed on the back surface of the second strip member 6, adjacent to the Velcro hook strip 10 on the back surface of the first strip member 4. It is envisaged that the second strip member 6 may be made shorter in length, in which case the size adjustment guide 26 may be printed on the back surface of the first strip member adjacent to the Velcro hook strip 10. The size adjustment guide displays three lines, one each for a standard 275 ml bottle 18, 375 ml bottle or can, and tapered or event cup. The lines give the user a rough indication of the position at which the Velcro strip 10 can be fastened to the Velcro adhesive portion 12 in order to pre-adjust the band 2 to fit the size and shape of the bottle 18, can or cup as chosen.

Arrow 32 indicates a position on the back surface of the second strip member 6 where the band's trade mark or brand name, such as “Wristy”, may be displayed. Printed messages, designs, or advertisements for other products and services may also be displayed on the back surface of the second strip member in the position indicated by arrow 30. Some examples of advertising may include displaying of company websites, slogans, and special offers.

Dashed line 34 shows the location of stitching through the first and second strip members which divides the pocket (as indicated by the number 14 in the embodiments of FIGS. 1 to 4) into a large pocket 27 and a small pocket 28.

FIG. 6 shows a front plan view of the second alternative band wherein the Velcro adhesive portion 12 covers the entire front surface of the first strip member 4. This improves range of size adjustment so that it may be applied to arms, wrists, ankles, bottles, cans, and cups of various shapes and sizes.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of another feature or features.

The reference to any prior art in this specification is not, and should not be taken as, an acknowledgement or any form of suggestion that such prior art forms part of the common general knowledge in Australia.

1. A band of flexible insulating material having two use modes, the band being adapted to be fitted on a limb of a user in a first use mode and adapted to surround and insulate a vessel in a second use mode.

2. The band according to claim 1 wherein the band comprises a pocket adapted to hold the user's personal items.

3. The band according to claim 1 wherein at least one of advertising or a size adjustable guide is displayed on the band.

4. The band according to claim 1 comprising, a first strip member having opposed ends, and fastening elements disposed proximate the opposed ends, the fastening elements being adapted to fasten the opposed ends together.

5. The band according to claim 4 wherein one of the fastening elements substantially covers an entire surface of the first strip member from end to end.

6. The band according to claim 4 wherein the fastening elements comprise hook and loop fasteners.

7. The band according to claim 4 comprising a second strip member which underlies and is attached to the first strip member.

8. The band according to claim 7 wherein a pocket is defined by a region between the first and second strip members.

9. The band according to claim 1 wherein the band is elasticised.

10. The band according to claim 1 wherein the band comprises a neoprene material.

11. The band according to claim 7 wherein at least one of the first and second strip members comprises a synthetic skin.

12. The band according to claim 1 comprising a curved resilient rod secured along opposed edges of the band so as to provide increased rigidity for the band and to give it a curved shape.

13. A method of marketing comprising using a band of flexible insulating material to display advertising, the band having two use modes whereby the band is adapted to be fitted on a limb of a user in a first use mode and adapted to surround and insulate a vessel in a second use mode.

14. A method according to claim 13 wherein the band of flexible insulating material comprises a band of flexible insulating material having two use modes, the band being adapted to be fitted on a limb of a user in a first use mode and adapted to surround and insulate a vessel in a second use mode.

15. (canceled)

16. (canceled)
